(19) United States
(12) Patent Application Publication
(10) Pub. No.: US 2016/0055165 A1
(43) Pub. Date: Feb. 25, 2016

(54) METHOD AND SYSTEMS FOR ARCHIVING A DOCUMENT

(71) Applicant: Yoav Shalom NAMIR, Tel Aviv (IL)

(72) Inventor: Yoav Shalom Namir, Tel Aviv (IL)

(21) Appl. No.: 14/782,601

(22) PCT Filed: Apr. 6, 2014
(86) PCT No.: PCT/IB14/60461

§ 371 Date: Oct. 6, 2015

Related U.S. Application Data
(60) Provisional application No. 61/809,375, filed on Apr. 7, 2013.

(51) Int. Cl. G06F 17/30; H04L 12/58; G06F 3/0488; G06F 3/0482

(52) U.S. Cl. CPC G06F 17/30073; G06F 3/0482; H04L 51/22; G06F 3/0488; G06F 17/30292; G06F 17/30091; G06F 17/30115

(57) ABSTRACT

an email comprising a content recipient module configured and operable to receive at least one portfolio scheme data piece comprising an archiving scheme data piece and optionally a docketing scheme data piece; receive a flow of emails from a content provider; and compile the flow of emails; thereby storing the flow of emails according to the portfolio scheme data piece.

### FIELD OF THE INVENTION

This invention relates generally to archives and particularly to archiving system and methods in computer environments.

### BACKGROUND OF THE INVENTION

Consuming and archiving the flow of written content nowadays are performed in the privacy of our home or office with expensive unrelated overhead. Even private home maintains soft and physical folders including day to day correspondence.

The handling of the flow of correspondence is the onus of the content recipient to decide how to approach the plethora.

### BRIEF DESCRIPTION OF THE DRAWINGS

In order to understand the invention and to see how it may be carried out in practice, embodiments will now be described, by way of non-limiting example only, with reference to the accompanying drawings, in which:

FIG. 1 is an illustration of an example networked content recipient machine in accordance with some embodiments.

FIG. 1B is an illustration of an example of networked internet users and portfolio scheme authority in accordance with some embodiments.

FIG. 2 illustrates example table structure of a portfolio scheme according to the present invention.

FIG. 3 illustrates example table structure of a portfolio scheme grammar rules according to the present invention.

FIG. 4 is an action diagram illustrating example interaction between an application and Portfolio scheme authority server according to embodiments.

FIG. 5 is a logic flow diagram for a process of updating portfolio scheme in email applications according to embodiments.

FIG. 6 is a logic flow diagram for a process of updating portfolio scheme on a content recipient machine in email applications according to embodiments.

FIG. 7 depicts a schematic overview of an exemplary content themes collection according to embodiments.

FIG. 8 depicts a schematic overview of a content theme objects collection graph according to embodiments.

FIG. 9 shows a schematic illustration utilization overview of an exemplary content theme objects collection according to embodiments.

FIG. 10 shows a schematic overview of an exemplary folder/file picker control according to embodiments.

FIGS. 11-13 show further example content recipient browsing capabilities according to embodiments.

### SUMMARY OF THE INVENTION

In a first aspect, the present invention is directed at an email or storage application comprising a content recipient module configured and operable to (a) receive at least one portfolio scheme data piece comprising an archiving scheme data piece and optionally a docketing scheme data piece; (b) receive a flow of emails from a content provider; and (c) compile the flow of emails; thereby storing the flow of emails according to the portfolio scheme data piece.

In some embodiments, the flow of emails is compiled according to the portfolio scheme data piece to update a dataset linked to the email application; thereby performing a query on said dataset.

In some embodiments, the flow of emails is compiled according to the portfolio scheme data piece to obtain an executable file system and optionally data set commands.

In some embodiments, the executable file system and optionally data set commands are executed to perform the file system and optionally data set commands.

The remote content recipient machine displays the emails in accordance with the portfolio scheme.

In some embodiments, a data piece of a portfolio scheme data piece is received from a remote location over the internet network.

The portfolio scheme data piece can comprise grammar rules for parsing the flow of emails and transforming the flow of emails to an executable file system and optionally data set commands. The grammar rules identify document conventions, content templates or document templates.

In some embodiments, the flow of emails is associated with a project.

In some embodiments, the dataset maintains project classification types and paired portfolio schemes data pieces; the project is associated to at least one project classification from the dataset; and the portfolio scheme data piece is selected from the dataset.

The portfolio scheme data piece was received at the content recipient machine from a portfolio scheme authority. The email application can enable the portfolio scheme authority to remotely control storing or retrieval; and optionally display of the flow of emails on the content recipient machine.

In some embodiments, the portfolio scheme authority is the content provider.

The flow of emails can comprise content theme objects regarding the project.

In some embodiments, the document convention, content templates or document templates is associated with content theme object types. The content theme object types can be paired to path information determining a location in a personal directory structure; the path information is used to store or display the flow of emails in the personal directory structure.

In addition, the content theme object types can be paired to path information determining a location in a personal directory structure; the path information is used to store or display the flow of emails in the content themes collection structure.

In a typical configuration, the flow of emails comprises human correspondence.

In some embodiments, the dataset maintains the content theme objects paired to the project; the data set object is updated according to the portfolio scheme in response to the flow of emails.

The portfolio scheme data piece includes a configuration of a graphical user interface in which the content recipient views the flow of emails.

In some embodiments, the human correspondence comprises natural language.

In some embodiments, the email application comprises a chat module displaying sent and received short messages stored or viewed according to the portfolio scheme data piece.

In a second aspect, the present invention is directed at an executed method for deploying messages at a content recipient machine comprising:

(a) receiving a portfolio scheme request from a content recipient application at a web service;

(b) executing a computerized method for identifying the portfolio scheme request; and

(c) transmitting a network response updating the portfolio scheme data piece at the content recipient machine.

In a third aspect, the present invention is directed at a computer executed method for deploying messages at a content recipient machine comprising:

(a) using a graphical user interface to define a grammar rule; the grammar rule include a document convention, a document template or a content template;

(b) paring the grammar rule with a portfolio scheme; the portfolio scheme is transmitted to the content recipient machine to deploy messages on said machine.

The present invention automatically parses the input data flow, to determine file system commands regarding the project. Thus flow of human correspondence in natural language is transformed to file system command. The content recipient views and handles the correspondence without the workload of organizing the correspondence. Information becomes readily available even where the content of the project is enormous and even where the recipient lacks the knowledge and expertise to organize such data items.

The flow of emails can be maintained in the personal folders communicatively linked with the email application.

In some embodiments, the flow of emails is compiled according to the portfolio scheme data piece which comprises an indexing data piece being applied on content of the flow of emails; thereby indexing said flow of emails.

The storing procedure can include transforming the folder structure in which the flow of emails are stored from a first folder structure to a second folder structure; the second folder structure is defined by the portfolio scheme data piece. The email application may allow browsing of the flow of emails maintained in the second folder structure being defined by the portfolio scheme data piece.

An optional and unique feature allows an arbitrary email being selected from the flow of email to be positioned in the second folder structure. In some embodiments, arbitrary email being selected is indicated in response to a user interface gesture which can be selected from the group consisting a click gesture, a double-click gesture, a finger slide gesture, a pointer move gesture, and a pointer hover gesture. In some embodiments, the email application is a cellular email application.

The portfolio scheme data piece can be received at the content recipient module from a portfolio scheme authority server. In some embodiments, the portfolio scheme data piece is received via a web service interface or a remote procedure call (RPC).

The email application optionally enables the portfolio scheme authority to remotely control the manner in which the flow of emails is displayed to a user. The control can be exercised by setting the portfolio scheme.

The flow of emails can be received via POP or IMAP protocols and processed by the email application.

In some embodiments, the portfolio display scheme defines a configuration of a graphical user interface in which the flow of emails is displayed.

In one embodiment, the email application further comprises a chat module displaying sent and received instant messages according to the portfolio display scheme data piece; the instant messages are graphically associated with a folder structure according to settings of the portfolio display scheme data piece.

The portfolio scheme server may be communicatively linked to a web interface allowing internet network users to input the grammar rules.

In another aspect, the present invention is directed to a computer executing a method for deploying emails at a content recipient machine comprising the procedures, features, and commands, and operations disclosed herein.

### DETAILED DESCRIPTION OF THE INVENTION

An email application, such as employing POP or IMAP (Microsoft Outlook, GMAIL etc'), is configure and designed herein to receive and apply portfolio scheme data pieces; and visualize the plethora in a computer generated modality in accordance with the portfolio scheme data pieces input. A feature allows for internet users to collaborate, share and exchange portfolio scheme data pieces and spread public wisdom with respect to the manner in which email and attachments should be organized (referred herein as the “portfolio scheme”). Work collaboration patterns between content providers and content mail recipients are facilitated.

In accordance with the present invention, “archiving” or “storing” refers to the process a document is placed and optionally stored and retrieved in a file system. In some embodiments, the present invention relates to email applications (or other applications) which places, stores or retrieves a file from a directory or a virtual directory.

“_{COOP}WORD™(s)” in the present application, shall mean strings of characters utilized in grammar rules, as defined herein. Document convention, content strings templates or document templates can be defined by _{COOP}WORD™(s). As shown herein, user can define _{coop}WORDs and grammar which can be used to parse email, documents and attachments. They may form a part of the portfolio scheme. _{COOP}WORD™(s) are building units that may define the grammar rules. The portfolio scheme authority server can be communicatively linked to stored grammar rules comprising the _{COOP}WORD™(s). The email application as described herein utilizes the _{coop}WORD™(s) to facilitate the computer generated modality. In this respect, the internet crowd includes content providers.

File systems have “directorie(s)” or “folder(s)” which allow grouping files into separate collections. Directory structures may be flat (i.e. linear), or allow hierarchies where directories may contain subdirectories, all of which are referred hereinafter “directory structure(s)”.

File system can support directory structures of arbitrary hierarchies. In some embodiments, a directory is paired with a content theme. In the context of the present invention, it is intended that a portfolio scheme authority (separate entity from the content recipient application and machine) could determine that email types and related documents will be archived under a directory paired to a preselected content theme. In other embodiment several directories are paired to content theme.

A “portfolio” is a set of content theme objects relating to a project and accumulating at the content recipient machine. In accordance with the present invention, a “portfolio scheme” is a scheme (predetermined plan) in which content themes are stored and organized in the file system of the content recipient machine. Portfolio scheme therefore includes a scheme which maps content theme objects to folder structures whether flat or hierarchical. A portfolio scheme therefore, in one embodiment, can be represented by a collection of content theme objects and paired folders. The collection can be utilized by variety of data structures such as dictionary mapping content theme object(s) to folder(s) (e.g. the destination folders in which the content themes are stored).

A “portfolio archiving scheme” is a predetermined plan in which content themes are archived or stored on the content recipient machine.

In some embodiments, the portfolio scheme includes a docketing scheme. A “docketing scheme” refers to a scheme in which content themes are stored in dataset (e.g. dataset/database linked to an email application) on the content recipient machine. Docketing scheme therefore includes a scheme which maps content theme objects to data items in a data set. A docketing scheme therefore, in one embodiment, can be represented by a collection of content theme objects and paired dataset queries. The data set can be a database, an SQL based storage and retrieval.

In some embodiments, the portfolio includes a portfolio display scheme. A “portfolio display scheme” refers to a scheme in which content themes are visualized to a user on the content recipient machine. Portfolio display scheme therefore includes a scheme which maps content theme objects to graphical user interface on the content recipient machine. A portfolio display scheme, in one embodiment, can be represented by a collection of content theme objects and paired graphical user interfaces. The graphical user interface can be a list box, graphical representation of a hierarchal tree, an item in a list box or a graphical representation of a tree node.

A “portfolio grammatical rules” or “grammar rules” refers to grammar rules in which emails and files are parsed and transformed to file system commands, the execution of which complies with the portfolio scheme.

In some embodiments, the grammatical rules include “docketing grammatical rules”. A portfolio grammatical rule refers to grammar rules in which emails and files are parsed and transformed to dataset commands (queries; SQL queries and commands; storage, update and retrieval of data), the execution of which complies with the docketing scheme.

These grammar rules can include rules directing a content recipient machine to parse the received emails, attachment or document according to predetermined document conventions, content templates or document templates. The document convention, content templates or document templates can be defined by _{COOP}WORD™(s).

The grammar rules thus also include the outcome of satisfying of the grammar rules. The outcome or result can be a predetermined file system command. For example, the result for grammar rule satisfaction can be automatic extraction of email attachments as well as optionally storing the attachment at a preset file system path/location. It can be stored at a location in a folder structure defined by the portfolio scheme. These grammatical rules are used, inter alia, to identify content theme objects in email or files.

In some embodiments, the file system commands automatically open, save or retrieve emails or other files and documents optionally immediately following receipt by the content recipient machine. In some embodiment, the content recipient machine is utilized to open, save or retrieved emails or other files and documents in a folder of a directory structure defined by a portfolio scheme authority remotely.

In some embodiments, the email or document is opened, retrieved or saved in a directory structure defined by a portfolio scheme authority or a content provider.

The portfolio grammar rule can determine the destination (i.e. location in the folder structure defined in the portfolio scheme) of the document according to the existence of a string template, content template, document convention or document structure detected in a received document or mail. The string template can be extracted or machine read from the content of the document or email.

In other embodiments, the content recipient machine can determine the directory destination in a directory structure in response to email flow received from the content provider machine. In some embodiments, regular expressions or regular expression objects such as Regex in C#, define string expressions. Such regular expression can be utilized to detect document conventions, document templates or content templates. String expressions can be in the form of _{coop}WORDs. The grammar rules can be a condition stating that if matches of a regular expression were found in an email, document or attachment, an outcome is prescribed. The outcome can be the execution of a file system command. The outcome may also be an indication of a content theme. In other examples the outcome can be visualization in a prescribed GUI object. Other example can include providing a dataset command to a dataset interfaces linked with the email application.

This can be implemented for example by a look-up table decoding (or mapping) each string template, document conventions, document templates or content templates to a destination directory or another system command to be executed, or an indication of a content theme. In other examples the outcome can be visualizing the match optionally in a prescribed GUI object. Other example can include providing a dataset command to a dataset interfaces linked with the email application.

In some embodiments, the regular expressions or the _{coop}WORDs can be utilized to index the content of the email, documents or attachments. The portfolio scheme data piece can comprise an indexing data piece being the regular expressions or the _{coop}WORDs. The email application compiles the flow of emails according to the portfolio scheme data piece which comprises an indexing data piece being applied on content of the flow of emails; thereby indexing said flow of emails. In specific embodiments, a set of such indexes are us

In addition, the string template, document conventions, document templates or content templates can be a continuous and non-continuous.

The grammar rules execution can be referred to a compilation of the emails, documents or attachments.

A “private archiving rules” is an archiving rule which is inaccessible for a content recipient to change. A “hidden archiving rules” is an archiving rule which is inaccessible for a content recipient to view.

In the realm of the present invention, a “content theme” and “content theme objects” shall refer to central topic, subject, document, email, content file or object of an office environment.

By way of non-limiting example, in an insurance company, a claim file structure can be a content theme. The content theme of the client can be recurrent and recognizable in the respective office environment.

A “content provider” is a person or organization who supplies written information about a project as defined herein. A “content recipient” is a person or organization who receives written information about a project from a content provider.

In accordance with the present invention, the term “remote” in reference to “local” shall refer to physically and geographically separated non overlapping physical locations situated at some distance away. “Local”, “local site” and “local location” in reference to “remote”, “remote location”, respectively merely refers to geographic separated non overlapping geographic locations.

The term “client location” or “remote client location” refers to a single or multiple locations where a document intended for docketing is available before the archiving. The remote client locations must have a client PC linked to a network accessible and connected to the internet.

A “project” is a business, scientific or social planned collaborative endeavour, a topic that two or more share. In some embodiments, the project is a business endeavor. In another embodiment, the business endeavor is a health related procedure. In another embodiment, the business endeavor is a billing related procedure. In another embodiment, the business endeavor is an insurance related procedure. In another embodiment, the business endeavor is a patent related procedure. In another embodiment, the business endeavor is an office related plan. In another embodiment, the business endeavor is an official related plan. In another embodiment, the business endeavor is a government related plan. In another embodiment, the business endeavor is a legal related procedure.

The term “document” shall have its ordinary meaning of a paper-like flat document.

A “private file system location” is a file system location inaccessible for a content recipient to change. A “hidden file system location” is a file system location inaccessible for a content recipient to view.

A “combo box” is a commonly used graphical user interface window control. This term shall have its ordinary meaning in the art (desktop application design in windows-like environments). It is a combination of a drop-down list or list box, allowing the user to either type a value directly into the control or choose from a list of existing options.

A “list box” is a graphical user interface window control that allows the user to select one or more items from a list contained within a multiple line text items.

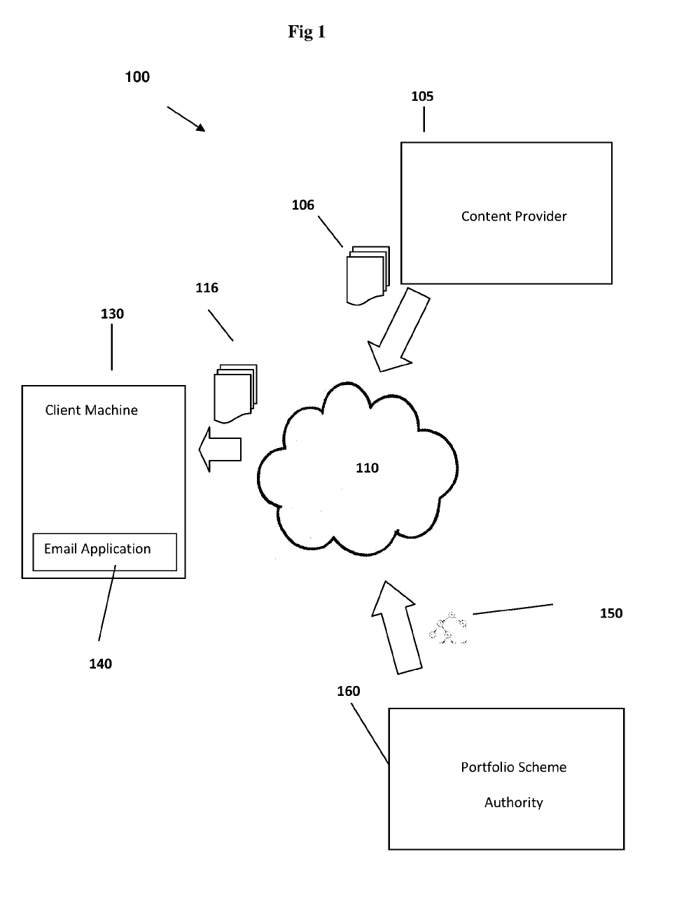

FIG. 1 is depicts an example of a content recipient machine in a networked environment 100 in accordance with some embodiments. The content provider 105 transmits in emails 106 to the content recipient machine. The content recipient receives the emails 116 on a content recipient machine 130. The content recipient i.e. the user typically uses an email application 140 to open the email being sent from the content provider 105. The email 106 can comprise attachments or alternatively be a document or file being sent over the internet 110. The email application further received data or web feed comprising a portfolio scheme 150 and portfolio scheme grammar rules. In some embodiments, the portfolio scheme is provided and transmitted over the internet from a portfolio scheme authority 160. This can be facilitated by a portfolio scheme authority server 160. The transmission of portfolio scheme data pieces can be provided by a web service or remote procedure call (RPC). As explained herein, one technique is to expose the web service to email application to request and receive portfolio scheme data feeds (over HTTP or other protocols).

The email application or another application located at the content recipient machine compiles the emails. The compilation of the email is performed using portfolio scheme grammar rules. The output of the compilation is file and information storage commands which are executed to store the email and or related information as well as visualization of the emails and email content according to the portfolio scheme.

FIG. 1B illustrates an exemplary and schematic view of an internet network connecting internet users to the Portfolio Scheme Authority 100B. The internet network configuration allows for internet users 161 to collaborate, share and exchange portfolio scheme data pieces 162, 163, 164. The collaboration is facilitated over an internet network 110. The portfolio scheme data pieces 162, 163, 164 can be received 150 at the Portfolio Scheme Authority 160. The portfolio scheme authority can be connected to the users via utilization of a Portfolio Scheme Authority server 160. In an embodiment, the portfolio scheme authority server 160 is communicatively linked to the internet network 110.

Communication to the internet can be facilitated by internet services servers (not shown in FIG. 1B). A non-limiting example of the internet services server is a Microsoft® IIS7 (Internet Information Server), an Apache Server111. The internet service server is configured to expose an HTTP web site, for example, having graphical user interface allowing the internet users 161 to input portfolio scheme data pieces 162, 163, 164 to a repository linked to the portfolio scheme authority server 160. Such repositories are known to the skilled artisan and can include a database infrastructure as MS SQL server.

In general, the portfolio scheme data pieces comprise information regarding portfolio scheme describing the manner in which email and documents should be organized and visualized by an email application. This is of particular importance as it allows unprofessional email application to enjoy the expertise of others more experienced users, such as, for example, professional content provider.

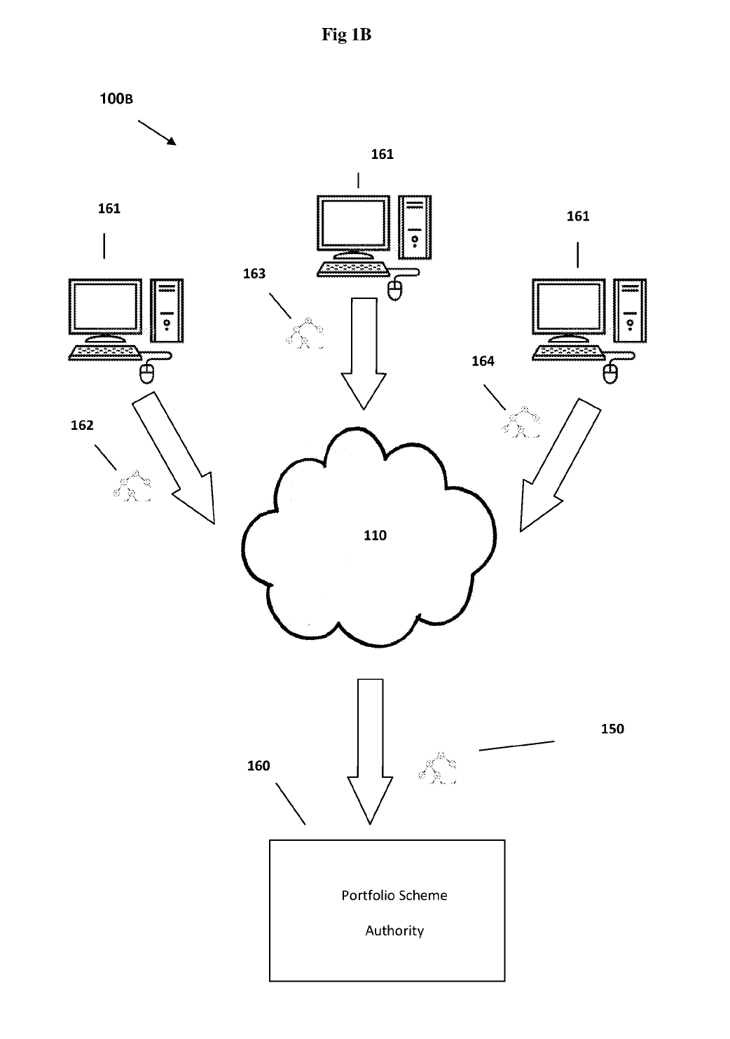

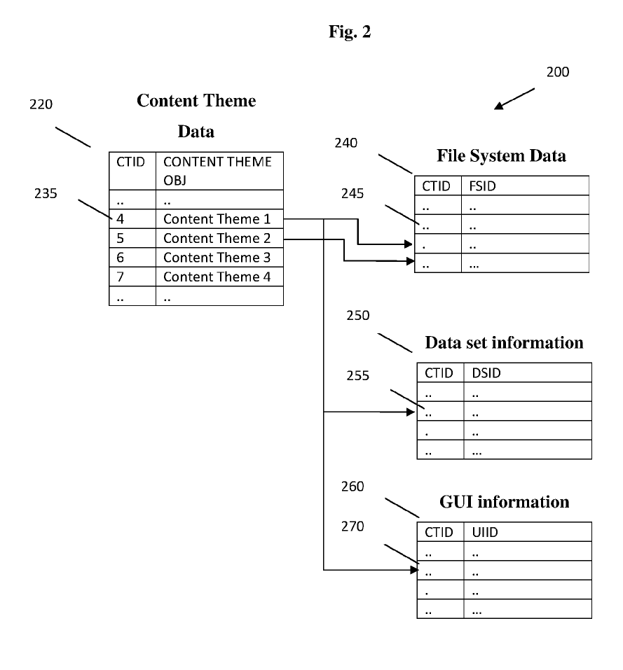

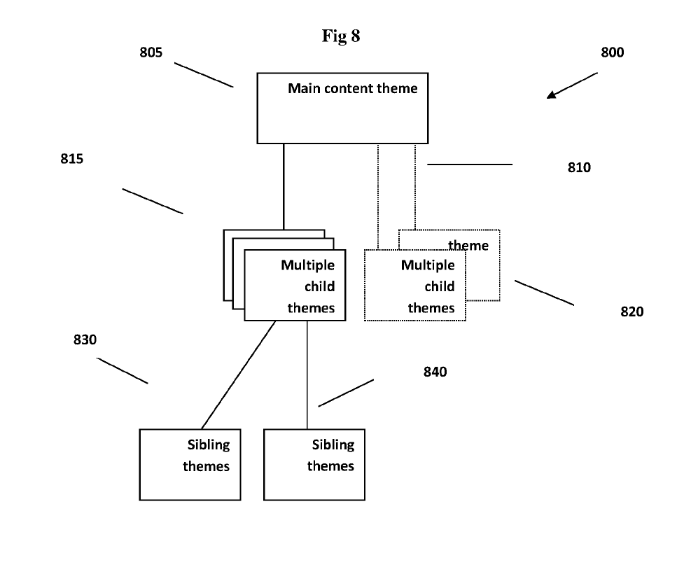

As elaborate herein, the portfolio scheme can include archiving, dataset organization and visualization methodologies which can be shared with email application users. The internet user can define a set of content themes as shown and explained, for example, FIGS. 2-3. The internet user can use string expressions (e.g. _{coop}WORDs) along with grammar rules which in his experience characterize a particular content theme in emails. Following the input of the _{coop}WORDs and grammar rules, provision of archiving, dataset and visualization rules procedures is enabled. Such information can be maintained as explained in FIGS. 2-3. By way of non-limiting example, FIG. 9 shows exemplary content theme collection in a hierarchical folder structure 900 provided and distributed by the portfolio scheme authority 160. The folder structure 900 can be a secondary folder structure in comparison to the default folder view structure provided by email applications.

The system disclosed herein, therefore, provides for transformation of set of emails organization in a first folder structure (e.g. default folder structure in personal folder of an email application) to a secondary folder structure.

FIG. 2 illustrates example table structure 200 of a portfolio scheme according to the present invention. An application according to embodiments may employ one or more tables or data tables to store content theme objects and relates file system, dataset and visualization information. Some example tables are conceptually illustrated in diagram 200. The portfolio scheme may be provided via a web or network feed comprising information defining content theme collection structure, dataset and visualization.

As stated herein, a portfolio scheme may comprise content theme object items. Content theme object items are enumerated at table 220. Each item may comprise a content theme id (CTID) and a content theme object name 235. Each content theme items may be mapped to either file system data 240, data set information 250 or/and GUI information 260. The file system data comprises items paring between a content theme object or CTID to file system commands 245 and optionally file system executables identified for example by file system id (FSID). The file system command can cause the recipient client machine to store the received email at a preset folder designed for the content theme. The preset folder can be a node in a folder structure used for visualizing the content theme collection.

The identification of content theme object in a document (i.e. email or attachment) is performed by extracting content from the document to obtain the content of the document; and searching whether the content of the document contains textual structures conforming to a grammar rule. Each content theme id (CTID) is associated to the grammar rule. If the content of the document contains textual structures conforming to the grammar rule, the content theme object associated with the CTID is thereby found. As shown in FIG. 2 the content theme object are mapped to respective file system data 240, data set information 250 or/and GUI information 260. The file system data 240, data set information 250 or/and GUI information 260 are a data piece of the portfolio scheme. Upon identification of a content theme object, the portfolio can be queried or look-up to identify a file system command associated with the object theme. Upon identification of a content theme object, the portfolio can be queried or look-up to identify a dataset command associated with the object theme. Upon identification of a content theme object, the portfolio can be queried or look-up to identify a file system command associated with the object theme.

In some embodiments, the email application or storage application executes an extraction procedure to obtain the content of the document; and search whether the extracted text contains a grammar rule. Where a grammar rule was satisfied the application can execute a file system commands, a data set command or a visualization command 245, 255, 265. Upon identification of a satisfied grammar rule, the portfolio can be queried or look-up to identify a file system command associated with the satisfied grammar rule. Upon identification of a satisfied grammar rule, the portfolio can be queried or look-up to identify a dataset command associated with the satisfied grammar rule. Upon identification of a satisfied grammar rule, the portfolio can be queried or look-up to identify a file system command associated with the satisfied grammar rule.

The data set information comprises items paring between a content theme object or CTID to dataset queries or commands 255 and optionally dataset executables identified for example by data set information id (DSID). The data set command can for example insert the content theme to a data table for docketing the content theme. As the email or documents are accumulated data tables accumulate data describing content themes appearing in the received emails.

The Graphical user interface information comprises items paring between a content theme object or CTID to user interface commands and configuration 265 and optionally executables identified for example by user interface information id (UIID). The user interfaces commands can associate for example content theme to particular graphical icons. In addition, the user interface commands direct the email application to employ a graphical user control or a graphical user form to visualize the content theme.

FIG. 3 illustrates example table structure 300 of a portfolio scheme grammar rules control according to the present invention. An application according to embodiments may employ one or more tables or data tables to store portfolio scheme grammar rules. Some example tables are conceptually illustrated in diagram 300. The portfolio scheme grammar rules can be received by the content recipient machine via a web or network feed comprising information defining grammar rules for compiling email and documents.

Table 305 may be employed to store and/or view messages and documents 310. Each message or document may be provided with Message identification (MID). The email application according to the present invention utilizes the grammar rules which may be located in table structure 315. The table 315 can pair the messages to the grammar rules. Each grammar rule can be provided with a Rule Identification (RID). The pairing of rule to messages enables identification of the messages which satisfied the grammar rules.

In embodiments of the present invention the grammar rules or RIDs can be paired to respective file system commands or executable. These can also be referred to in the present invention as archive scheme. The archive scheme table example is shown as table 320. The rules can be paired to archive scheme items. The latter are typically assigned with Archive Scheme Identification (ASID). Each of the ASID can be mapped to preset directory or file system commands 325 (ASCOM).

The file system command can cause the recipient client machine to store the received email 310 at a preset folder designed for a content theme being identified by the respective RID. The preset folder can be a node in a folder structure used for visualizing the content theme collection.

In embodiments of the present invention the grammar rules or RIDs can be paired to respective data set commands or executable. These can also be referred to as a docketing scheme. The docketing scheme table example is shown as table 335. The rules can be paired to data set scheme items. The latter are typically assigned with Data Set Identification (DSID). Each of the DSID can be mapped to preset data set commands or queries 330 (DSCOM).

The data set command can cause the recipient client machine to query or insert a content theme object to a data table. The data table can be viewed with the received email 310 at a preset folder designed for a content theme object; the content theme being identified by the respective RID. The preset folder can be a node in a folder structure used for visualizing the content theme collection.

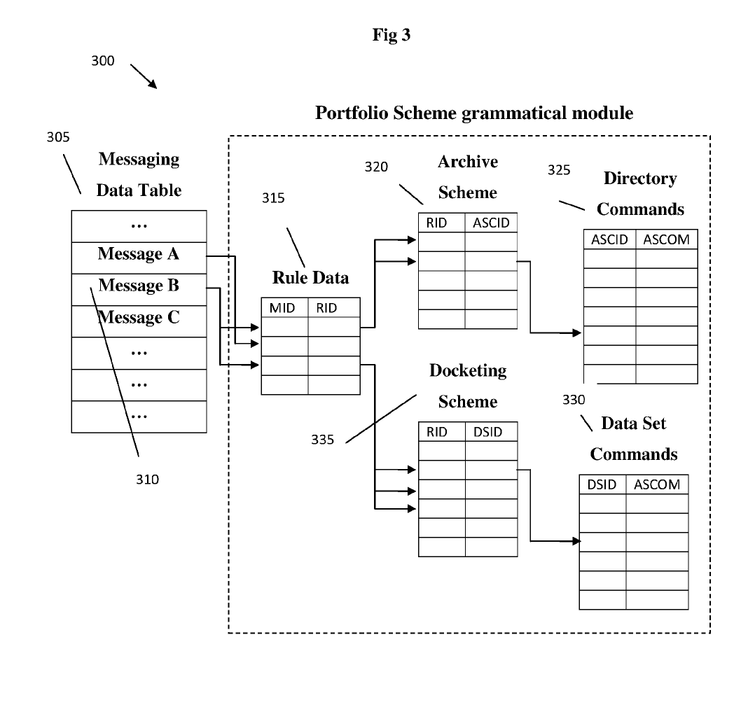

FIG. 4 is an action diagram illustrating example interaction between an application and portfolio scheme authority server according to embodiments. Diagram 400 displays the interactions between for example an email application 410, web service 420 and a portfolio scheme authority 430. The systems and applications of the present invention can include further components and interactions.

In exemplary settings, an email application 410 may initiate a process with a portfolio scheme authority request 415, upon which the web service 420 may submit a query to the portfolio scheme authority server 430 by querying rule data 422. The portfolio scheme authority 430 may respond by returning data collection of rules 424. Thereafter, the web service may respond with respect to the email application by transmitting a portfolio scheme data piece 416.

In embodiments of the present invention, the web service 420 may submit a query to the portfolio scheme authority server 430 by querying portfolio scheme data items 426. The portfolio scheme authority 430 may respond by returning data collection of portfolio scheme data 428. The web service may respond with respect to the email application by transmitting a portfolio scheme data piece 417.

In other embodiments of the present invention, the web service 420 may submit a query to the portfolio scheme authority server 430 by querying docketing scheme data items 429. The portfolio scheme authority 430 may respond by returning a data collection of docketing scheme data 432. Thereafter, the web service may respond with respect to the email application by transmitting docketing scheme data piece 418.

In embodiments, a flow of emails received by the email application 410 applies the portfolio scheme data piece 419.

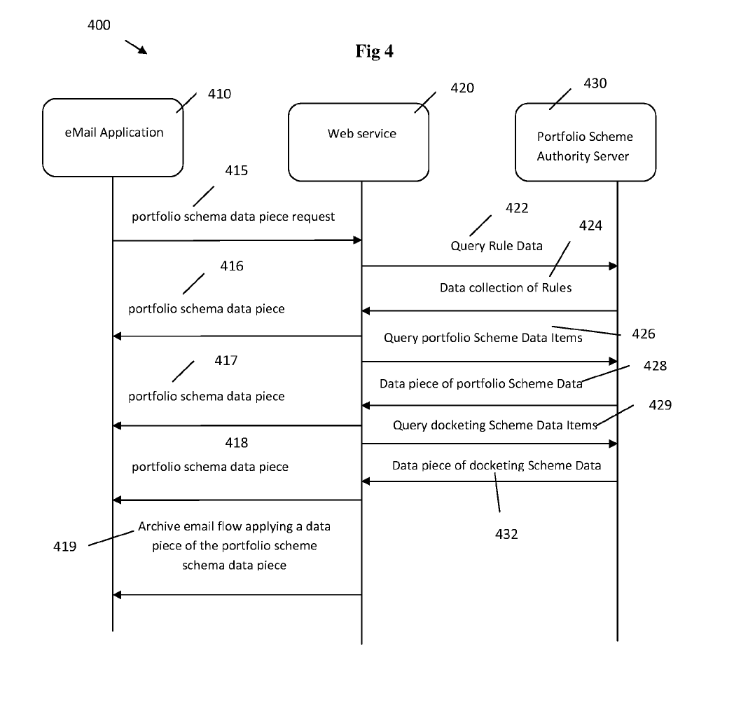

FIG. 5 is logic flow diagram for a process of updating portfolio scheme 500 in email applications according to embodiments. Content recipients mail application can request a portfolio scheme authority to send data pieces of a portfolio scheme. As the data piece is received by content recipient machine it enables compilation of a flow of emails being received from a content provider.

Process 500 may begin with operation 510 as a portfolio scheme is identified at the portfolio scheme authority. At operation 520 content recipient client machines can be provided with portfolio scheme data pieces. Thereafter, an operation for receiving the portfolio scheme data pieces at the content recipient client machine can follow. At operation 530 the portfolio scheme data piece is updated at the content recipient i.e. client machine.

The process 500 can be performed as a web service or a service at server side as well as a 3^{rd} party.

The operations of process 500 are provided for illustration purposes. Similar processes can be employed as well as changing the sequential order of the operations described.

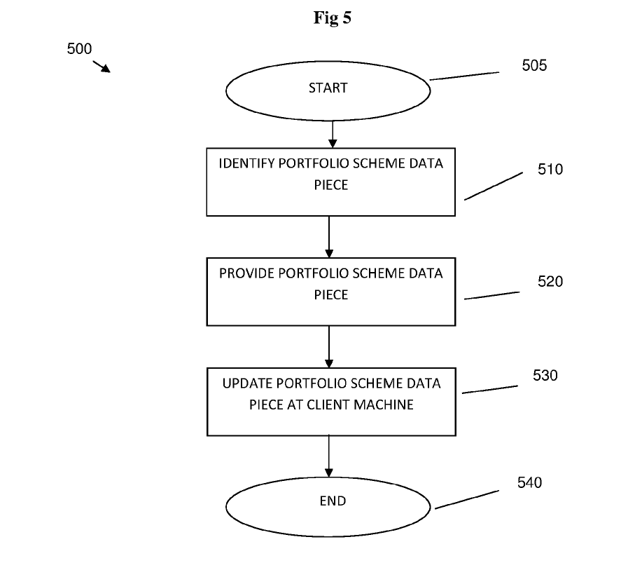

FIG. 6 is a logic flow diagram for a process 600 of receiving portfolio schemes on a content recipient machine. At operation 610 content recipients mail application can request a portfolio scheme authority to send data pieces of a portfolio scheme. As the data piece is received at operation 620 by content recipient machine it enables compilation of a flow of emails being received from a content provider.

At operation 630 content recipient client machines can update the portfolio scheme with the received data pieces. Thereafter, an operation 640 for applying the portfolio scheme at the content recipient client machine can follow. Operation 640 can include a step of receiving a file over the internet and apply the portfolio scheme to compile the file e.g. an email. The compilation of the file with the portfolio data scheme can automatically perform file system commands as well as data set commands.

The operations of process 600 are provided for illustration purposes.

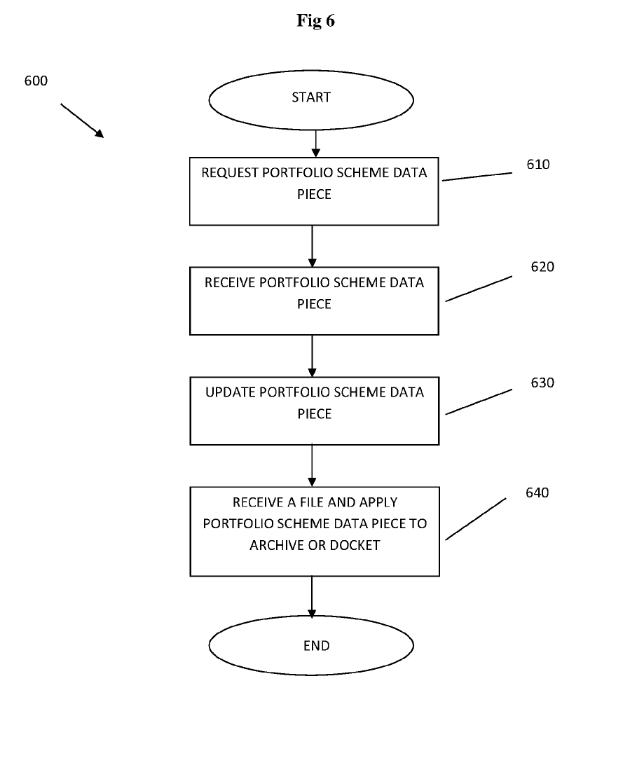

FIG. 7 depicts a schematic overview of an exemplary content theme objects collection 700 according to embodiments. Child content theme 715 is a mere example of a content theme data item. A content theme object accordingly can be a topic, subject, or object of an office environment, email, file or document. In the present invention, content theme data items can be arranged in a hierarchal structure as shown i.e. the relations of content theme object instances are represented by a graph data structure (or specifically by a tree data structure).

By way of non-limiting example, diagram 700 shows a graph having content theme object instances as nodes 705, 715, 710, 730 and 740. The relationship between content theme object instances is represented by an edge which connects the respective content theme object instances. For example, the content theme instance 715 is a child content theme of 705; content theme instance 730 is a sibling of content theme instance 740; the parent of both is the content theme instance 710.

The method, applications and systems of the present invention classify emails and file documents. The emails and documents can be classified to an appropriate content theme which is maintained in a folder/directory. The classification can be performed by executing storage procedures to the emails and documents. The portfolio scheme defines the manner in which content themes are distributed in the folder structures as described herein.

The collection of content themes is mapped to a portfolio folder structure. The portfolio folder structure is visualized according to the portfolio display scheme which can be received by email application from a portfolio scheme authority server. The content provider is provided herein with the ability to control the manner in which the user browses the emails.

In some embodiments, the portfolio scheme defines a transformation from a first folder structure in which the emails are stored to a second folder structure allowing the content recipient to enjoy smart visualization of the emails which conforms to the portfolio scheme.

It is a non-limiting object of the portfolio scheme to determine a working convention forcing both the content provider who sends the content and the content recipient to obey thereto.

The portfolio scheme further defines the data objects which are valid under the permitted portfolio scheme. Thus, both the content provider and the content recipient handle data objects according to a mutual working convention.

In some options, the portfolio scheme is determined by a portfolio scheme authority which can be the content provider or a 3^{rd} party.

The content recipient can use the email application according to a single portfolio scheme or a plurality of portfolio schemes. The portfolio schemes hierarchies can be incorporated within a main hierarchy e.g. as several sub tree structures that can be merged into a single graph structure. This can be achieved by defining the root note of a sub tree and associating a selected node in the main hierarchy to reference the root node of the sub tree.

Thus, a content recipient can enjoy reading and browsing through emails and file documents in accordance to several portfolio schemes which were defined by several portfolio scheme authorities or content providers.

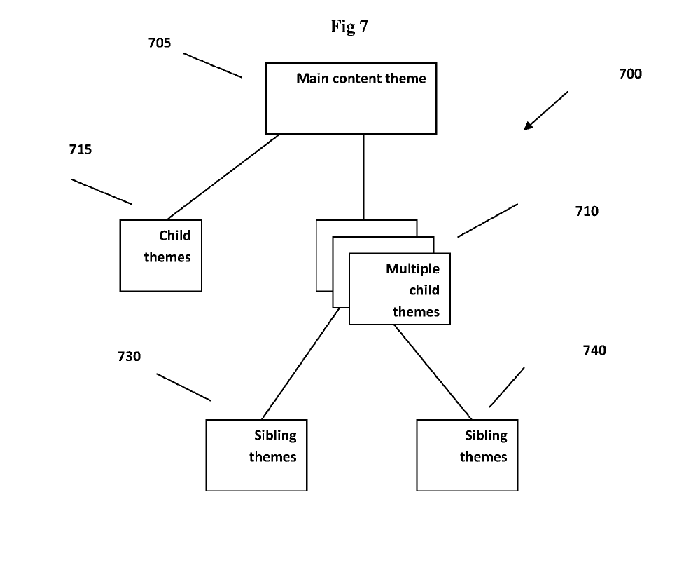

FIG. 8 depicts a schematic overview of a content theme collection graph according to embodiments. Graph 800, in a non-limiting example, shows that the main content theme object collection can comprise several portfolio schemes. The main content themes 805 collection is shown in FIG. 8. In this example, the main portfolio collection comprises three sub-trees for three content theme sub collections. The first portfolio scheme defines content theme items 815, 830 and 840. The second and third portfolio schemes 820 are provided by discontinued lines.

FIG. 9 shows a schematic illustration utilization overview of an exemplary content theme collection in a hierarchical folder structure 900. Several portfolio sub schemes are provided. The root node of the content theme collection 900 is the main inbox 905. The later can represent the root node of a personal folder in an email application. Portfolio schemes 915 are content themes: Blue Cross Family Insurance and NYU. By way of non limiting manner, the email application of the present invention maintains emails and documents. The emails relating the Blue Cross Family Insurance are classified to content theme 915. As will be shown herein, the content themes may be visualized by GUI user controls defined by the portfolio display scheme. The user will be able to access the email and documents classified under content theme such as 915 by actuating a user gesture (e.g. double-click). Emails and documents classified under NYU 915 can be actuated a user gesture.

In some embodiments, the hierarchical folder structure 900 defines a second folder structure with respect to a first folder structure. The portfolio scheme can define the manner in which to transform emails ordered in the first folder structure to a second folder structure maintaining the emails.

The emails and documents received can be automatically and autonomously classified under the relating content theme.

Similarly, content themes object collection 900 includes content theme 910 maintaining medical records. In the particular non-limiting example, Sheba hospital 940 and Sinai Health Organization 930 are content providers. The later are sending the content recipient variety of email and documents. The content recipient lacks the knowledge and know-how relating to organization of the emails plethora. The email application of the present invention in configured and operable to receive a portfolio scheme data piece from the portfolio authority (being sent over network from the portfolio authority server); and apply the portfolio scheme to automatically and autonomously archive and docket emails and documents.

Content theme object collection 900 classifies emails and documents being received from Sheba hospital according to the applied portfolio scheme. The email application applying the scheme will execute file system commands to handle the emails and documents received from the content provider, Sheba hospital. The email application applying the portfolio scheme will execute commands to handle the emails and documents received from the content provider, Sheba hospital.

As shown in content themes collection 900 the Sheba Hospital maintains several content themes predetermined as a part of the portfolio scheme applied. Documents and emails relating to imaging will be classified under content theme 960. CTs, MRI images and x-rays 970 are also shown for exemplary purposes. In addition, content themes collection 900 comprises further content themes to store chemistry results, blood tests, billing and release notes 950.

In accordance with the present invention, the content recipient can browse through the content theme object collection. The content recipient received a flow of emails and documents via email application, for example. The content provider controls the portfolio scheme defining how the emails and documents are archived and in what manner they are docketed or visualized. The content recipient can enjoys the privilege of having mass email related information “pre-ordered” for his benefit in accordance with the portfolio scheme.

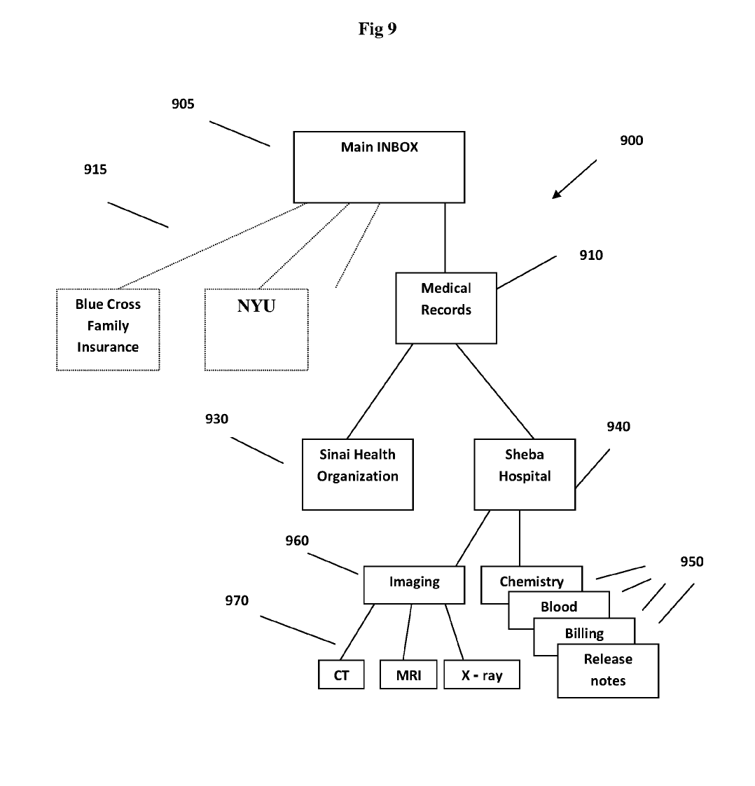

FIG. 10 shows a schematic overview of an exemplary folder/file picker control 1000. The folder/file picker 1000 is a GUI control allowing content recipient to browse the emails and files maintained in content theme object collection 700, 800 and 900. In this instance, the folder/file picker displays a showcase of a first layer in the content theme object collection hierarchy under the Main INBOX 1010 i.e. Blue Cross Family Insurance 1015, NYU content 1020, First National Bank documentation 1025 and Brinkster hosting service 1030. Several portfolio sub schemes are provided in the content theme object collection.

In this example, the folder structure of the Blue Cross Family Insurance folder is determined by the Blue Cross Family Insurance instead of the content recipients. The structure of NYU content theme 1020 is determined by the NYU instead of the content recipients. Thus the folder structure of the content theme collection can be provided by 3^{rd} parties, the portfolio authorities which can be the content providers.

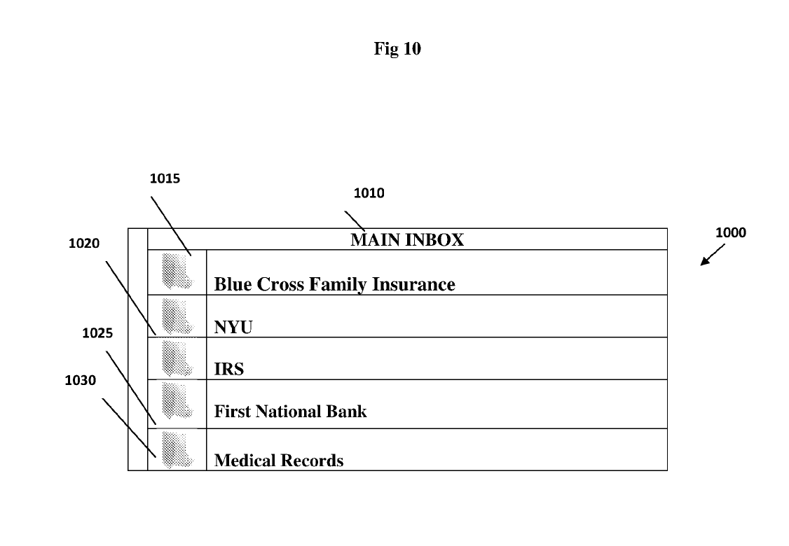

FIGS. 11-13 show a further example of content recipient browsing capabilities. FIG. 11 shows content which is located in the content theme “Medical Records” 1110. This content theme was defined by the portfolio scheme authority to include two content themes in the form of folder nodes: Sinai Health Organization 1115 and Sheba Hospital 1120. The content recipient was therefore freed from the need to manage the archiving and docketing of emails and document received from these two institutions. The email application bestowed with the appropriate portfolio scheme archives the emails and documents in accordance with to the archiving rules defined in the portfolio scheme or archiving scheme. This procedure can be done automatically.

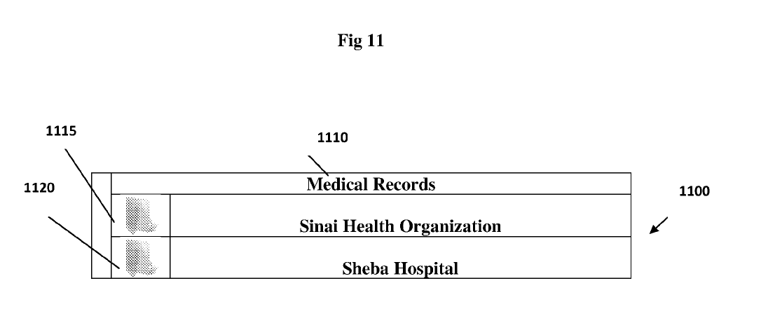

FIG. 12 shows content which is located in the content theme “Sheba Hospital” 1210. This content theme was defined by the portfolio scheme authority to include four content themes in the form of folder nodes: Chemistry 1220, Blood tests 1230, Billing 1240 and Release notes 1250.

In some embodiments, the portfolio scheme comprises a docketing scheme. In some embodiments, the docketing scheme includes notification data set and an update rule or command to insert notification into the notification data set. FIG. 12 exemplifies the display of such a notification 1215 being automatically inserted in accordance with the docketing rules. A content theme object of a personal contact 1260 is also shown. In some embodiments, the docketing scheme maintains such contact data set to associate contacts to other content theme in the collection structure as chosen by content provider or content scheme authority. The content provider or the content scheme authority is in the best position to allow the content recipient to browse the content theme object collection in the data structure which suits best e.g. contacts associated to particular content relevant to the associate with the assigned contact.

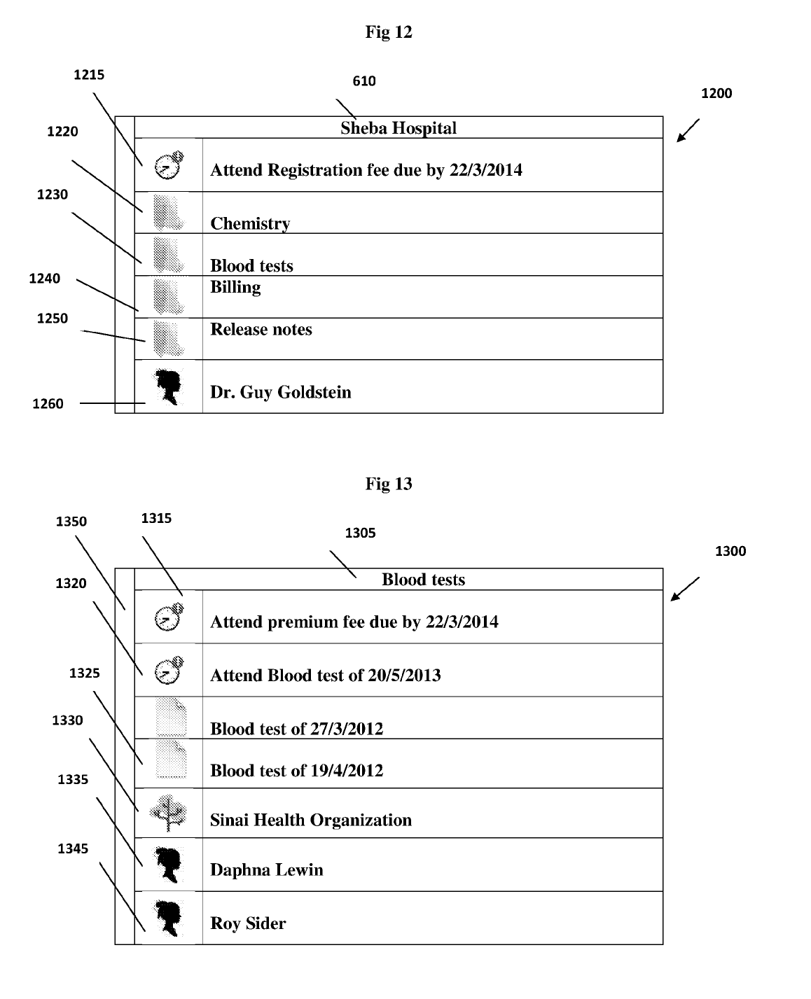

FIG. 13 shows content which is located in the content theme “Blood tests” 1305. The notification data set includes notifications 1315 and 1320. The notification data set can be updated from emails. The data set could be updated by way of processing the incoming emails and extracting data set command from the natural text of the email. This is performed by compiling an incoming email or document using the grammar rules to identify content theme object complying therewith. The data set could be updated by way of processing the incoming emails and extracting the data set command from a document convention of the email. In some embodiments, the applications and methods of the preset invention employ a look up table comprising pairs of document convention or string templates mapped to data set commands or file system commands. These can direct the application to archive, save or update a resource on a secondary storage device on the content recipient machine, and optionally store the resource at a particular path (absolute or relative) determined in accordance with the portfolio scheme. The resource can be also an attachment document.

Thorough the present application the email application of the present invention includes in some embodiment a web-based email application.

In other embodiments, the present invention is directed an email comprising a bundle of encoded commands automatically directing remote content recipient machines to save the email and display the email in accordance with the portfolio scheme. The encoded commands can be in the form of portfolio scheme grammar rules.

In some embodiments, the present invention is directed to an email application comprising the content recipient control module configured and operable to listen for web data feeds; the data feed includes embedded commands or portfolio scheme grammar rules data pieces.

In some embodiments, the content recipient control module is linked to a rule lookup table comprising preset rules paired data items of: <string templates, a project data set commands>; the table is queried according to search criteria to determine project data set commands matching the input data.

“Email application” in the present invention shall mean an email service including sending, receiving, and managing e-mail and documents over mail protocols as POP or IMAP (POPS/4, IMAP3/4 etc′). Email application encompasses Microsoft Outlook and Outlook Express as well as Web Mail services as Gmail. Optionally, email applications further manages a calendar and contacts, such as friends and business associates.

In an embodiment, the present invention is directed to an email application email or storage application comprising a content recipient module configured and operable to (a) receive at least one portfolio scheme data piece comprising an archiving scheme data piece (b) reference a bundle of emails maintained in a personal folder linked to the email application; and (c) compile the bundle of emails; thereby storing the bundle of emails according to the portfolio scheme data piece.

This feature is particularly important during runtime of the email application as it enables the email application to dynamically load/receive a portfolio scheme data piece; and apply the data piece to transform a first folder structure in which the bundle of emails are stored and/or visualized to a second folder structure. Content providers sending emails plethora being received by the email application are permitted to send the portfolio scheme data piece to the email application; and provide compilation of the bundle of emails to the second folder structure in which the bundle of emails is stored and/or visualized.

In some embodiments, the content recipient module is packaged in an add-on package; the add-on is configured and adapted to be installed on the email application.

The person skilled in the art would appreciate that the features of email application described herein above are also applicable in the currently described email application. In particular, the portfolio scheme data piece can optionally include an archiving scheme data piece. In an additional embodiment, the portfolio scheme data piece can optionally include a portfolio display scheme data piece.

The email application is characterized in that the flow of emails is compiled according to the portfolio scheme data piece comprising an indexing data piece to be applied on the content of the flow of emails (bundle of emails); thereby indexing said flow of emails. The indexing can be performed by obtaining a first string key. e.g. comprised in the portfolio scheme data piece; and compiling the content of the flow of email or attachments to obtain a first set of emails each member of the set have content that is matching with the first string key. The indexing can further be performed by obtaining a second string key comprised in the portfolio scheme data piece; and compiling the content of the flow of emails or attachments to obtain a second set of emails each member of the set have content that is matching with the second string key.

By way of non-limiting example, FIG. 9 can represent a second folder structure defined by the portfolio scheme data piece. Thus, following receipt of the portfolio scheme data piece the email application transforms the bundle of emails for the first folder structure (for example, the default folder structure provided in the email application) to the second folder structure which can be provided remotely by the content provider via a portfolio scheme authority server.

In some embodiments, content theme e.g. 910 references the first set of emails which have content that is matching with the first string key. Content theme 940 can reference the second set of emails which have content matching with the second string key. In some embodiments, an edge connecting content themes (e.g. 910 and 940) in hierarchical folder structure represents a condition according to which the child content theme (positioned at a lower layer in the hierarchy e.g. 940 via-a-vis 910) references those members emails or attachments found in both the first and second set of emails.

FIGS. 1 to 8 and the related description(s) are applicable to elaborate possible features of the present invention embodiment.

The person skilled in the art would know common techniques for extraction of text or content from documents. The content of documents in the present invention is natural content i.e. human readable. The content consists of text that may be tabulated and edited for human use and comprising [A-Z][0-9][a-z] characters. By way of non-limiting example, documents include WORD documents, PDF documents, text document, images and emails. Each of can be processed to extract text there from. By way of non-limiting example, WORD documents can be analyzed dynamically, in run-time, to expose the DOM (Document Object Model) structure in order to obtain the document content. PDF can be extracted, for example, by utilization of Adobe® API or itext® Programmable PDF Software. The content of a text document is typically accessible via file stream objects provided by most file system platforms. Email content of Microsoft® .msg files, for example, are accessible by .net platform which is configured to expose the Outlook® interoperability object.

Content of page images (e.g. scanned images) can be produced utilizing an image analysis module, as an OCR module, available by numerous 3^{rd} party APIs e.g. IRIS® OCR solutions.

The above specification, examples and data provide a complete description of the manufacture and use of the composition of the embodiments. Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims and embodiments.

1. An email application comprising a content recipient module configured and operable to (a) receive at least one portfolio scheme data piece comprising predetermined configuration for mapping content theme data item(s) to destination folders in which the content themes are to be stored; (b) receive a flow of emails from a content provider; and (c) compile the flow of emails; thereby storing the flow of emails according to the portfolio scheme data piece.

2. (canceled)

3. An email application of claim 1 wherein the flow of emails is maintained in the personal folders communicatively linked with the email application.

4. An email application of claim 3 wherein the flow of emails is compiled according to the portfolio scheme data piece which comprises an indexing data piece being applied on content of the flow of emails; thereby indexing said flow of emails.

5. The email application claim 4 wherein the flow of emails comprises natural human language correspondence and the compilation of the flow of emails comprises compilation of the natural human language correspondence contained within the emails; thereby the storing of the flow of emails includes transforming the personal folder structure in which the flow of emails are stored from a first folder structure to a second folder structure; the second folder structure is defined by the portfolio scheme data piece; the second folder structure is a tree structure maintaining the content theme data items; wherein the flow of emails is positioned in the second folder structure.

6. The email application of claim 5 characterized in permitting a user of the email application to browse of items from the second folder structure being in accordance with the portfolio scheme data piece.

7. The email application of claim 6 wherein an arbitrary email being selected from the flow of email is positioned in the second folder structure.

8. The email application of claim 7 wherein the email being selected is indicated in response to a user interface gesture.

9. The email application of claim 8 wherein the user interface gesture is one selected from the group consisting a click gesture, a double-click gesture, a finger slide gesture, a pointer move gesture, and a pointer hover gesture.

10. An email application of claim 9 wherein the portfolio scheme data niece comprises grammar rules for parsing the flow of emails and transforming the flow of emails to executable file system commands; the grammar rules being configured and operable to identify a document content convention; wherein the document content convention is associated with the content theme data items; the flow of emails is compiled according to the portfolio scheme data piece to obtain an executable file system command.

11. (canceled)

12. An email application of claim 10 wherein the portfolio scheme data piece comprises a portfolio display scheme to display the flow of emails in accordance with the portfolio display scheme; the portfolio display scheme defines a configuration of a graphical user interface in which the flow of emails is displayed.

13. The email application of claim 12 wherein the portfolio scheme data piece is received at the content recipient module from a portfolio scheme authority server at a remote location over the internet network via a web service interface or a remote procedure call (RPC) communicatively linked to the portfolio scheme authority server.

14-15. (canceled)

16. The email application of claim 13 wherein the email application enables the portfolio scheme authority to remotely control the manner in which the flow of emails is displayed; the control is exercised by setting the portfolio scheme.

17-20. (canceled)

21. The email application of claim 16 wherein the portfolio scheme server is communicatively linked to a web interface allowing internet network users to input the grammar rules and set the portfolio scheme data piece remotely.

22. (canceled)

23. The email application of claim 21 wherein the portfolio scheme authority is a content provider.

24-25. (canceled)

26. The email application of claim 23 wherein the flow of emails is received via POP or IMAP protocols and processed by the email application.

27-31. (canceled)
